(19) United States
(12) Patent Application Publication
(10) Pub. No.: US 2019/0023102 A1
(43) Pub. Date: Jan. 24, 2019

(54) SYSTEM AND METHOD FOR MANAGING REFRIGERATION TEMPERATURES IN STORAGE AREAS OF A VEHICLE

(71) Applicant: Walmart Apollo, LLC, Bentonville, AR (US)

(72) Inventors: Greg A. Bryan, Centerton, AR (US); Benjamin D. Enssle, Bella Vista, AR (US); Cristy C. Brooks, Cassville, MO (US); David C. Winkle, Bella Vista, AR (US); John P. Thompson, Bentonville, AR (US); David B. Brightwell, Bella Vista, AR (US)

(21) Appl. No.: 16/028,715

(22) Filed: Jul. 6, 2018

Related U.S. Application Data
(60) Provisional application No. 62/534,742, filed on Jul. 20, 2017.

(51) Int. Cl. B60H 1/00

(52) U.S. Cl. CPC B60H 1/00842

(57) ABSTRACT

A first duct, second duct, third duct, and fourth duct extend across at least a part of a first zone and at least a part of a second zone of a vehicle, and each are configured with one or more vents. Each of the vents has an adjustable opening allowing the transfer of air produced by first or second refrigeration units from the duct. An adjustment is caused to one or more of the position of the openings of the vents, the operation of the first refrigeration unit, and the operation of the second refrigeration unit. The adjustment is effective to maintain a first temperature in the first zone and a second temperature in the second zone.

### CROSS-REFERENCE TO RELATED APPLICATION

This application claims the benefit of the following U.S. Provisional Application No. 62/534,742 filed Jul. 20, 2017, which is incorporated herein by reference in its entirety.

### TECHNICAL FIELD

These teachings relate generally to vehicles that include refrigeration units and, more specifically, managing the temperature in storage areas of vehicles.

### BACKGROUND

Vehicles transport various types of goods from location to location. Perishable products are transported and often require the use of a refrigeration unit to ensure that the products do not become unusable. Unfortunately, the refrigeration unit fails on some occasions.

Previous approaches of handling refrigeration unit failure relied upon the use of a dedicated back-up refrigeration unit when the original unit had failed. However, the back-up unit would not be operated until the original unit had failed. This was a significant waste of system resources because the back-up unit was expensive, but was typically seldom needed.

Another problem associated with previous approaches was that these approaches failed to adequately cool products being stored in the vehicle. For example, some products required colder temperatures than other products. It proved difficult to regulate the temperatures in the storage area of a vehicle so that each product was maintained at its optimum temperature as circumstances changed. For instance, previous approaches failed to adequately manage temperatures within the storage area of a vehicle as the outside temperature changed and/or as the products themselves changed.

In any case, previous approaches were typically ad-hoc and resulted in the inefficient allocation of system resources. Additionally, many products perished due to the above-mentioned problems, resulting in financial losses for shipping companies and their customers.

### BRIEF DESCRIPTION OF THE DRAWINGS

The above needs are at least partially met through provision of approaches that manage the refrigeration of storage spaces in vehicles particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram as configured in accordance with various embodiments of these teachings;

FIG. 4 comprises a flowchart as configured in accordance with various embodiments of these teachings.

### DETAILED DESCRIPTION

Generally speaking, many of these embodiments provide for a system and method that manages the refrigeration of products that are transported in vehicles. The vehicle has two (or more) refrigeration units and each refrigeration unit has two ducts, one duct supplying chilled air and the other duct supplying freezer air. The units may, in some instances, operate at the same time, while at other times, only one of the units is operating. The positions of vents that are disposed through the ducts, and the operation of the two refrigeration units are dynamically controlled to maintain desired temperatures in one or more zones of the vehicle.

In many of these embodiments, a system for refrigerating products includes a communication network, a vehicle, and a control circuit. A central processing center is coupled to the communication network. The vehicle includes a transceiver circuit that is coupled to the communication network and is configured to receive instructions from the central processing center via the communication network as the vehicle is moving. The vehicle also includes a storage area, and the storage area includes a bulkhead that divides the storage area into a first zone and a second zone. The vehicle further includes a first refrigeration unit and a second refrigeration unit. Each of the refrigeration units create freezer air having a first temperature and chilled air having a second temperature. The first temperature being less than the second temperature.

The vehicle still further includes a first duct (extending from the first refrigeration unit) supplying freezer air, a second duct extending from the first refrigeration unit (supplying chilled air), a third duct extending from the second refrigeration unit (supplying freezer air), and a fourth duct extending from the second refrigeration unit (supplying chilled air). The first duct, the second duct, the third duct, and the fourth duct extend across at least a part of the first zone and at least a part of the second zone, and each are configured with one or more vents. Each of the vents has an adjustable opening allowing the transfer of air from the duct to portions of the storage area.

The control circuit is coupled to the transceiver circuit and to the adjustable vents, and is configured to, form instructions that cause an adjustment to one or more of: a position of the openings of the vents, an operation of the first refrigeration unit, and an operation of the second refrigeration unit. The adjustment is effective to maintain the first temperature in the first zone and the second temperature in the second zone.

In aspects, the adjustment is determined by one or more of: a first measured temperature in the first zone and a second measured temperature in the second zone, a measured exterior temperature of the environment exterior to the vehicle, a first operational condition of the first refrigeration unit and a second operational condition of the second refrigeration unit, or a first type of product stored in the first zone and a second type of product stored in the second zone. Other examples are possible.

In other examples, the instructions define a number of vents to open and close in the first zone and the second zone. In still other examples, the number of vents to open and close in the first zone and the second zone is determined at the central processing center based at least in part upon sensed temperature readings obtained in the first zone and the second zone, the readings being transmitted to the central processing center by the transceiver circuit via the network. In other aspects, the position of the vents includes a fully open position and a fully closed position.

In still other aspects, the instructions cause the first refrigeration unit and the second refrigeration unit to be operating at the same time. In other aspects, failure of the first refrigeration unit is detected by the control circuit. Upon detection of the failure, the control circuit causes a message identifying the failure to be transmitted from the transceiver circuit to the central processing center via the network.

In some examples, the bulkhead includes a damper. In other examples, the damper is adjustable by the control circuit. In yet other examples, the bulkhead is a curtain-like bulkhead, or an inflatable bulkhead.

In aspects, controlling the vents could enable at least one temperature zone. For instance, four zones (quarter-trailer) may be controlled. With the use of a bulkhead and dynamically controlled vents, there could be three or four zones, one or two on each side of the bulkhead. In still other examples, there could be more than one bulkhead. For another example, a zone could be implemented by directing the output of one or more vents at one or more specific cargo items or pallets.

In others of these embodiments, instructions from a central processing center are received via a network at a vehicle as the vehicle is moving. The vehicle has a storage area, and the storage area includes a bulkhead that divides the storage area into a first zone and a second zone. The vehicle includes a first refrigeration unit and a second refrigeration unit, and each of the refrigeration units supply freezer air with a first temperature and chilled air with a second temperature. The first temperature is less than the second temperature.

Freezer air is supplied from a first duct extending from the first refrigeration unit. Chilled air is supplied from a second duct extending from the first refrigeration unit. Freezer air is supplied from a third duct extending from the second refrigeration unit. Chilled air is supplied from a fourth duct extending from the second refrigeration unit.

The first duct, the second duct, the third duct, and the fourth duct extend across at least a part of the first zone and at least a part of the second zone, and each are configured with one or more vents. Each of the vents has an adjustable opening allowing the transfer of air from the duct. An adjustment is caused to one or more of the position of the openings of the vents, the operation of the first refrigeration unit, and the operation of the second refrigeration unit. The adjustment is effective to maintain the first temperature in the first zone and the second temperature in the second zone.

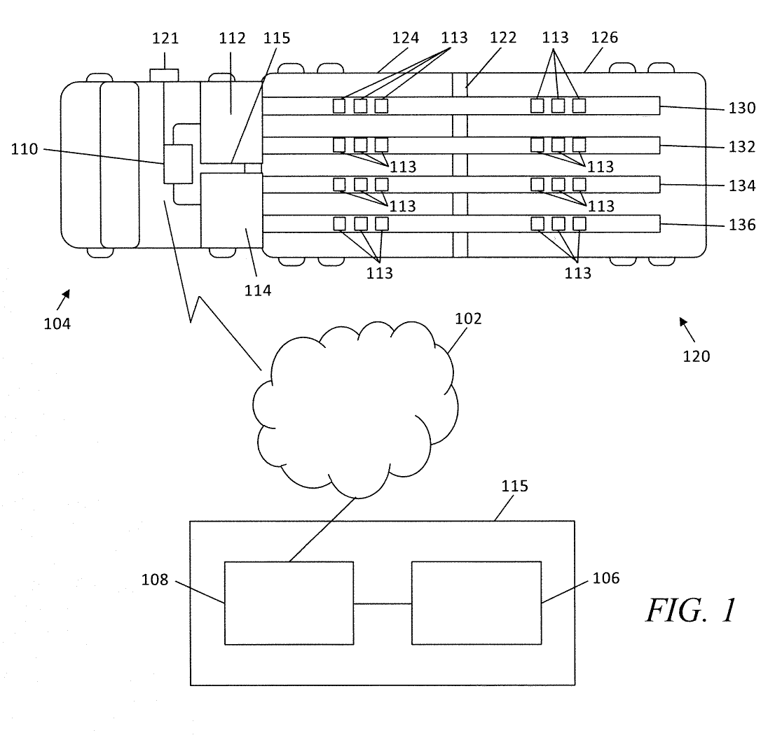

Referring now to FIG. 1, a system maintaining the temperatures of refrigerated products being transported in a vehicle includes a communication network 102, a vehicle 104, a database 106, and a control circuit 108. The vehicle 104 includes a transceiver circuit 110 and the transceiver circuit 110 is communicatively coupled to the network 102.

The communication network 102 may be any network or combination of networks. In examples, the network 102 may be the cloud, the internet, cellular networks, local or wide area networks, or any combination of these (or other) networks. The network 102 may include various electronic devices (e.g., routers, gateways, and/or processors to mention a few examples).

The vehicle 104 is any vehicle such as a truck, tractor-trailer, or automobile that is configured to store and move products. The vehicle 104 also includes a storage area 120, the storage area 120 including a bulkhead 122 that divides the storage area into a first zone 124 and a second zone 126. The vehicle 104 further includes a first refrigeration unit 112 and a second refrigeration unit 114. Each of the refrigeration units 112, 114 create freezer air having a first temperature and chilled air having a second temperature. The first temperature is less than the second temperature. In examples the freezer air is effective to keep products in a frozen state, while the chilled air is sufficient to maintain products in a non-frozen, but chilled state.

The vehicle 104 still further includes a first duct 130 extending from the first refrigeration unit 112 and supplying freezer air, a second duct 132 extending from the first refrigeration unit 112 and supplying chilled air, a third duct 134 extending from the second refrigeration unit 114 and supplying freezer air, and a fourth duct 136 extending from the second refrigeration unit 114 and supplying chilled air. The first duct 130, the second duct 132, the third duct 134, and the fourth duct 136 extend across at least a part of the first zone 124 and at least a part of the second zone 126, and each are configured with one or more vents 113. The ducts 130, 132, 134, and 136 may be hollow passageways that direct air from the refrigeration units 112, and 114 to the storage areas of the vehicle. In one example, the ducts 130, 132, 134, and 136 are formed by four walls that are arranged at right angles to each other.

Each of the vents 113 extends through wall of the ducts 130, 132, 134, and 136, and include adjustable openings allowing the transfer of air from the interior of the duct to storage areas in the vehicle. In these regards an actuation mechanism 115 (e.g., a motor that has levers, arms, or other structures to adjust an amount of opening in a particular vent) may be coupled to the vents 113. The actuation mechanism 115 is also coupled to the transceiver 110. Instructions received at the transceiver 110 control the actuation mechanism 115, which in turn controls the amount of opening (e.g., open, closed, or percent open) of the vents 113. In other examples, separate actuation mechanisms are disposed at each of the vents 113.

The transceiver circuit 110 is configured to transmit and receive information from the vehicle 104. The transceiver circuit 110 may allow a driver in the vehicle 104 via the network 102 to transmit and receive messages from a central control center 115. As mentioned, instructions are also received from the control circuit 108 that adjust the amount of opening of the vents 113. The transceiver 110 is additionally coupled to the first refrigeration unit 112 and the second refrigeration unit 114. The same or other instructions that control vents 113 control the operation of the refrigeration units 112 and 114 (e.g., activating or deactivating these units). The refrigeration units 112 and 114 may also report failures (or the operational status) of themselves to the control circuit 108.

Sensors 117 are disposed in the first zone 124 and the second zone 126 and are coupled to the transceiver 110. In aspects, the sensors 117 measure the temperature of the zones and the sensed temperatures are sent to the control circuit 108 via the transceiver 110 and network 102.

The control circuit 108 and the database 106 are disposed at the central control center 115. The transceiver circuit 110 may implemented as any combination of electronic hardware and software.

The database 106 is disposed at a central processing center 114 and stores information concerning products stored in the storage area 120 including the pattern of product storage (i.e., which products are stored in the first zone 124, and which products are stored in the second zone 126). Other information that can be stored in the database 106 includes the cooling requirements of the products, the number of products, and the type of products. Some or all of this information can be used by the control circuit to issue instructions to control the operation of the refrigeration units 112 and 114, and/or the vents 113.

The control circuit 108 is disposed at the central processing center 114 and is communicatively coupled to the network 102. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

In other examples, the control circuit 108 is disposed at the vehicle 104. In still other examples, the functions of the control circuit may be split between the vehicle 104 and the central processing center 114.

The control circuit 108 is coupled to the transceiver circuit 110 and to the adjustable vents 113, and is configured to, form instructions that cause an adjustment to one or more of: a position of the openings of the vents (e.g., using the actuation mechanism 115), an operation of the first refrigeration unit 112, and an operation of the second refrigeration unit 114. The adjustment is effective to maintain the first temperature in the first zone 124 and the second temperature in the second zone 126. The zones 124 and 126 are generally self-contained storage areas in which a prescribed temperature is maintained.

In aspects, the adjustment is determined by one or more of: a first measured temperature in the first zone and a second measured temperature in the second zone (e.g., using the sensors 117); a measured exterior temperature of the environment exterior to the vehicle (e.g., using a temperature sensor 121 coupled to the exterior of the vehicle 104); a first operational condition of the first refrigeration unit 112 and a second operational condition of the second refrigeration unit 114 (as reported by these units); and a first type of product stored in the first zone and a second type of product stored in the second zone (with the product type being stored in the database 106). Other examples are possible.

In other examples, the instructions define a number of vents 113 to open and close in the first zone 124 and the second zone 126. In still other examples, the number of vents 113 to open and close in the first zone and the second zone is determined at the central processing center 115 based at least in part upon sensed temperature readings obtained in the first zone 124 and the second zone 126 (obtained by the sensors 117). The readings are transmitted to the central processing center by the transceiver circuit 110 via the network 102. In other examples, the position of the vents 113 includes a fully open position and a fully closed position.

In aspects, the instructions cause the first refrigeration unit 112 and the second refrigeration unit 114 to be operating at the same time. In other aspects, failure of the first refrigeration unit 112 is detected by the control circuit 108. In examples and upon detection of the failure, the control circuit 108 causes a message identifying the failure to be transmitted from the transceiver circuit 110 to the central processing center 115 via the network 102.

In some examples, the bulkhead 122 includes a damper. In other examples, the damper that has a position that is adjustable by the control circuit 108. In yet other examples, the bulkhead is one of: a curtain-like bulkhead, or an inflatable bulkhead.

As for the inflatable bulkhead, this may be a balloon-like structure deployed or secured somewhere in or at the vehicle (e.g., at the ceiling or the roof of the vehicle) that would inflate to displace the amount of air at the top of the vehicle thus increasing the efficiency and speed of cooling. In other words, the inflatable bulkhead would act as an air displacement device.

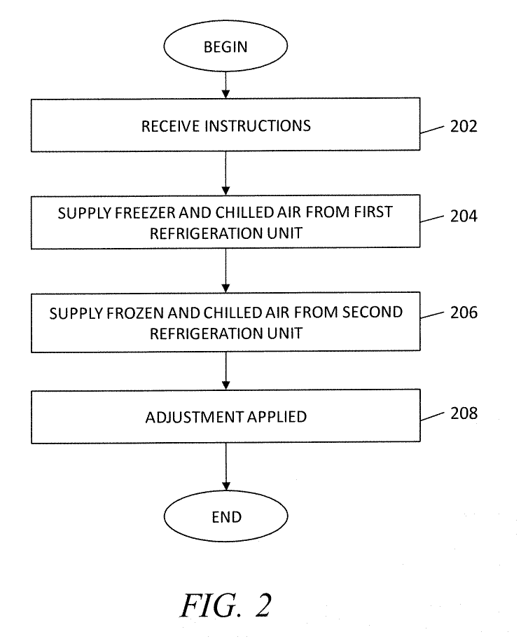

Referring now to FIG. 2, an approach for taking action upon the failure of a refrigeration unit at a vehicle is described. At step 202, instructions from a central processing center are received via a network at a vehicle as the vehicle is moving. The vehicle has a storage area, and the storage area includes a bulkhead that divides the storage area into a first zone and a second zone. The vehicle includes a first refrigeration unit and a second refrigeration unit, and each of the refrigeration units supply freezer air with a first temperature and chilled air with a second temperature. The first temperature is less than the second temperature.

At step 204, freezer air is supplied from a first duct extending from the first refrigeration unit. Chilled air is supplied from a second duct extending from the first refrigeration unit.

At step 206, freezer air is supplied from a third duct extending from the second refrigeration unit. Chilled air is supplied from a fourth duct extending from the second refrigeration unit.

The first duct, the second duct, the third duct, and the fourth duct extend across at least a part of the first zone and at least a part of the second zone, and each are configured with one or more vents. Each of the vents has an adjustable opening allowing the transfer of air from the duct. The ducts may be formed of walls that are configured as passageways to move air from the refrigeration unit to the storage areas of the vehicle. In one example, the ducts may be pipes or pipe-like structures. In other examples, the ducts are formed from four walls that form an interior passageway for directing or moving the air. Other examples are possible.

At step 208, based upon the instructions, an adjustment is caused to the position of the openings of the vents, the operation of the first refrigeration unit, or the operation of the second refrigeration unit. The adjustment is effective to maintain the first temperature in the first zone and the second temperature in the second zone.

Various approaches can be used to determine the adjustment that is communicated in the instructions. For instance, the type of items being transported, the cooling requirements of these items, and the outside air temperature may all be analyzed to determine an appropriate action. Other examples are possible.

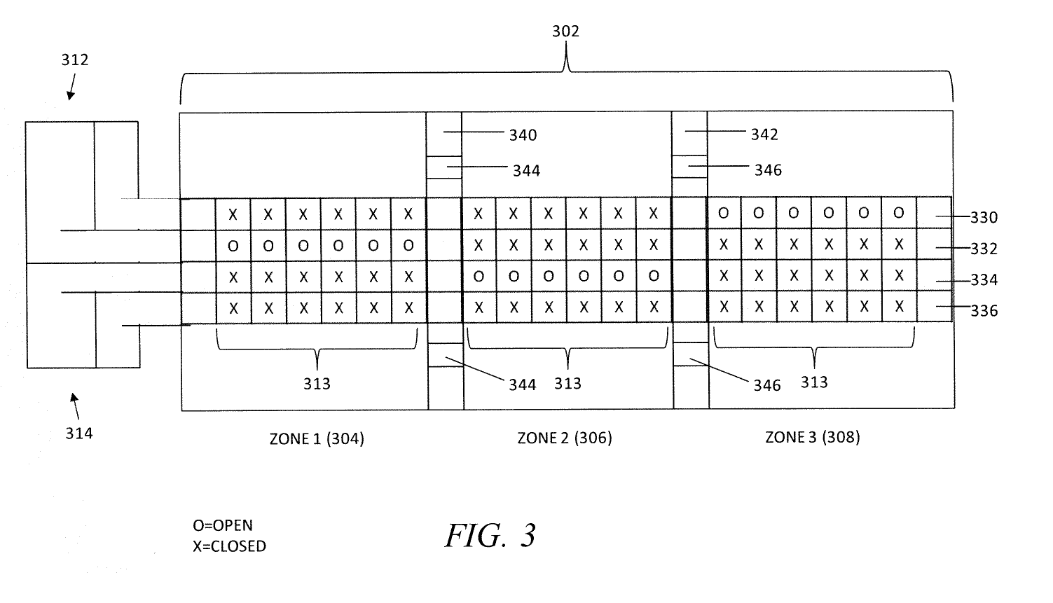

Referring now to FIG. 3, one example of a layout of a vehicle 300 is described. The vehicle 300 includes a storage area 302, which is divided into a first zone 304, a second zone 306, and a third zone 308.

A first refrigeration unit 312 and a second refrigeration unit 314 produce chilled air and freezer air. A first duct 330 extending from the first refrigeration unit 312 and supplying freezer air, a second duct 332 extending from the first refrigeration unit 312 and supplying chilled air, a third duct 334 extending from the second refrigeration unit 314 and supplying freezer air, and a fourth duct 336 extending from the second refrigeration unit 314 and supplying chilled air. Freezer air is of sufficient temperature (e.g., 0 degrees F.) to keep a product frozen, while chilled air is sufficient to maintain a sufficient temperature (e.g., 32 degrees F.) to keep a product chilled (prevent the product from decaying), but not freeze the product.

Various vents (shown as boxes in the ducts and labeled as 313) pierce the ducts and allow air in the ducts to flow into the zones 304, 306, and 308. In this example, both refrigeration units 312 and 314 are operating. An “x” indicates a particular vent 313 is closed, while an “o” indicates that the vent is open. The pattern so-formed (for each of the zones 304, 306, and 308) forms a vent pattern. Various vent patterns may be stored in memory (e.g., the data storage 106 of FIG. 1) and be implemented given a set of input conditions. In this example, the first zone 304 stores frozen items or products, the second zone 306 stores frozen items or products, and the third zone 308 stores chilled items or products.

The zones are separated bulkheads 340 and 342. In aspects, the bulkheads 340 includes dampers 344, and the bulkhead 342 includes dampers 346 which allow for the circulation of air upon refrigeration unit failure. The dampers are controlled openings (that can be opened or closed) that allow air to circulate as between the zones 304, 306, and 308. Thus, even without any refrigeration unit operating it may be possible to maintain an adequate temperature within the zones 304, 306, and 308 to preserve some products. In yet other examples, the bulkhead is one of: a curtain-like bulkhead, or an inflatable bulkhead.

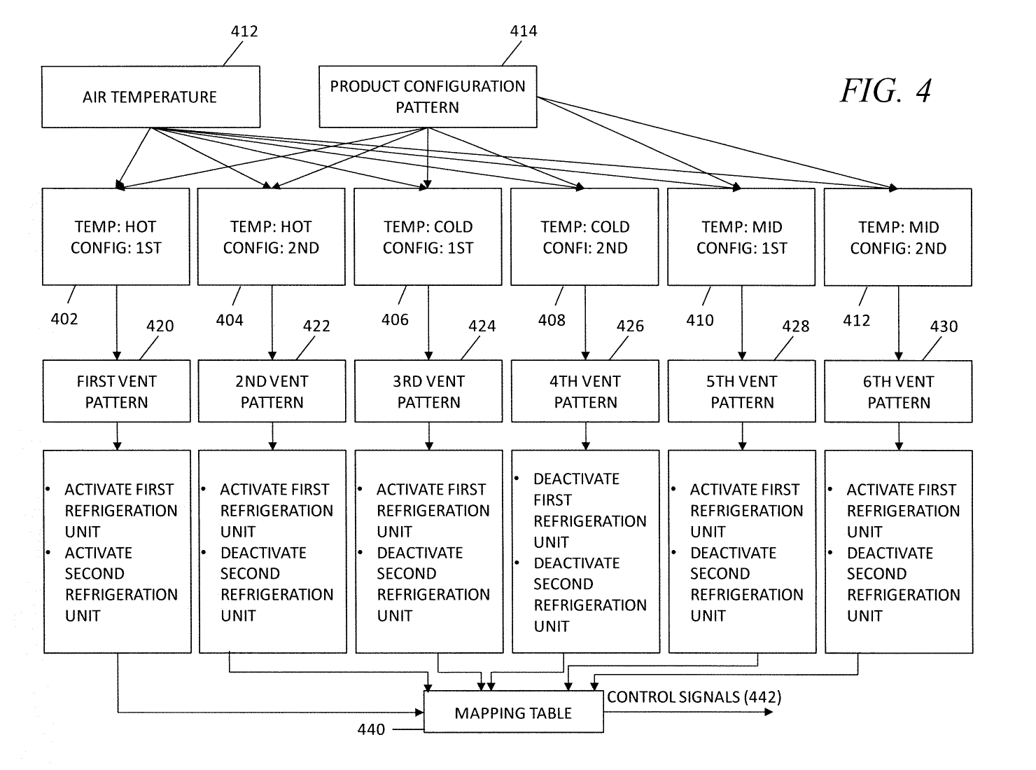

Referring now to FIG. 4, one example of an approach that issues instructions to manage the air temperature in zones within a vehicle is described. This example assumes that a sensor measures the outside air temperature. Two refrigeration units are used.

The outside air temperature will be considered “hot” when the measured temperature is above a first threshold. The outside air temperature will be considered “cold” when the measured temperature is below a second threshold. The outside air temperature will be considered “middle range” when the temperature is between the first threshold and the second threshold. In some aspect, “hot” is above a threshold, while “cold” is below the same threshold.

The vehicle is assumed to have two compartments with two possible product configurations allowable in this example. In a first product configuration, one compartment has ice cream (requiring frozen air), and the other vegetables (requiring chilled air). In a second product configuration, both the first and the second compartments include vegetables.

Two air ducts extend from each refrigeration unit. Each duct as vents that have openings, which can be adjusted to be opened and closed. A vent pattern describes which vents are open and closed. In this example, there will be five patterns. Within a pattern, “x” represents that a particular vent is closed, while an “o” represents that a particular vent is open. In this example, two vents are present within each zone per duct (with four vents total per duct). It will be appreciated that there is not a dedicated back-up that can only be used upon failure of a main unit. In other words, both units can be used or active during normal operation.

The approach uses the measured outside air temperature 412, a product configuration pattern 414 to determine a vent pattern and activation pattern for refrigeration units (on or off) to use. The vent pattern and activation pattern are translated into control signals (e.g., instructions) that operate the physical devices that implement the selection.

At step 402, when the temperature is “hot” and the first product configuration exists, the first refrigeration unit is activated, the second refrigeration unit is activated, and a first vent pattern 420 is utilized. The refrigeration unit operation pattern and the selected vent pattern are effective to maintain the zones in the desired temperatures.

At step 404, when the temperature is “hot” and the second product configuration exists, the first refrigeration unit is activated, the second refrigeration unit is deactivated, and a second vent pattern 422 is utilized. The refrigeration unit operation pattern and the selected vent pattern are effective to maintain the zones in the desired temperatures.

At step 406, when the temperature is “cold” and the first product configuration exists, the first refrigeration unit is activated, the second refrigeration unit is deactivated, and a third vent pattern 424 is utilized. The refrigeration unit operation pattern and the selected vent pattern are effective to maintain the zones in the desired temperatures.

At step 408, when the temperature is “cold” and the second product configuration exists, the first refrigeration unit is deactivated, the second refrigeration unit is deactivated, and a fourth vent pattern 426 is utilized. The refrigeration unit operation pattern and the selected vent pattern are effective to maintain the zones in the desired temperatures.

At step 410, when the temperature is “middle range” and the first product configuration exists, the first refrigeration unit is activated, the second refrigeration unit is deactivated, and a fifth vent pattern 428 is utilized. The refrigeration unit operation pattern and the selected vent pattern are effective to maintain the zones in the desired temperatures.

At step 412, when the temperature is “middle range” and the second product configuration exists, the first refrigeration unit is activated, the second refrigeration unit is deactivated, and a sixth vent pattern 430 is utilized. The refrigeration unit operation pattern and the selected vent pattern are effective to maintain the zones in the desired temperatures.

In these examples, the vents may be controlled by a motor and/or other actuation devices. A control signal (or signals) 442 is sent from a control circuit to the motor/actuation apparatus to open or close the vent to fit the pattern. Similarly, the same or a separate control signal is sent from the control circuit to the refrigeration units to either activate the refrigeration unit or deactivate the refrigeration units. A mapping table 440 may be used to translate a determined vent pattern 420, 422, 424, 426, 428, or 438 and activation pattern (on or off) for the refrigeration units into the appropriate control signal or signals 442 that actually implement and control the pattern within the vehicle. Other examples of data structures can also be used.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system for refrigerating products, the system comprising:
a communication network;
a central processing center coupled to the communication network;
a vehicle, the vehicle including:
a transceiver circuit coupled to the communication network, the transceiver circuit configured to receive instructions from the central processing center via the communication network as the vehicle is moving;
a storage area, the storage area including a bulkhead that divides the storage area into a first zone and a second zone;
a first refrigeration unit and a second refrigeration unit, each of the refrigeration units creating freezer air having a first temperature and chilled air having a second temperature, the first temperature being less than the second temperature;
a first duct extending from the first refrigeration unit and supplying freezer air, and a second duct extending from the first refrigeration unit and supplying chilled air;
a third duct extending from the second refrigeration unit and supplying freezer air, and a fourth duct extending from the second refrigeration unit and supplying chilled air;
wherein the first duct, the second duct, the third duct, and the fourth duct extend across at least a part of the first zone and at least a part of the second zone, and each are configured with one or more vents, each of the vents having an adjustable opening allowing the transfer of air from the duct;
a control circuit coupled to the transceiver circuit and to the adjustable vents, the control circuit being configured to, form the instructions, the instructions causing an adjustment to one or more of: a position of the openings of the vents, an operation of the first refrigeration unit, and an operation of the second refrigeration unit, the adjustment being effective to maintain the first temperature in the first zone and the second temperature in the second zone.

2. The system of claim 1, wherein the adjustment is determined by one or more of: a first measured temperature in the first zone and a second measured temperature in the second zone; a measured exterior temperature of the environment exterior to the vehicle; a first operational condition of the first refrigeration unit and a second operational condition of the second refrigeration unit; and a first type of product stored in the first zone and a second type of product stored in the second zone.

3. The system of claim 1, wherein the instructions define a number of vents to open and close in the first zone and the second zone.

4. The system of claim 1, wherein the number of vents to open and close in the first zone and the second zone is determined at the central processing center based at least in part upon sensed temperature readings obtained in the first zone and the second zone, the readings being transmitted to the central processing center by the transceiver circuit via the network.

5. The system of claim 1, wherein the position of the vents includes a fully open position and a fully closed position.

6. The system of claim 1, wherein the instructions cause the first refrigeration unit and the second refrigeration unit to be operating at the same time.

7. The system of claim 1, wherein a failure of the first refrigeration unit is detected by the control circuit.

8. The system of claim 7, wherein upon detection of the failure, the control circuit causes a message identifying the failure to be transmitted from the transceiver circuit to the central processing center via the network.

9. The system of claim 1, wherein the bulkhead includes a damper.

10. The system of claim 9, wherein a position of the damper is adjustable by the control circuit.

11. The system of claim 1, wherein the bulkhead is one of: a curtain-like bulkhead, or an inflatable bulkhead.

12. A method for refrigerating products, the method comprising:
receiving instructions from a central processing center via the network at a vehicle as the vehicle is moving, wherein the vehicle has a storage area, the storage area including a bulkhead that divides the storage area into a first zone and a second zone, wherein the vehicle includes a first refrigeration unit and a second refrigeration unit, each of the refrigeration units supplying freezer air with a first temperature and chilled air with a second temperature, the first temperature being less than the second temperature,
supplying freezer air from a first duct extending from the first refrigeration unit;
supplying chilled air from a second duct extending from the first refrigeration unit;
supplying freezer air from a third duct extending from the second refrigeration unit;
supplying chilled air from a fourth duct extending from the second refrigeration unit;
wherein the first duct, the second duct, the third duct, and the fourth duct extend across at least a part of the first zone and at least a part of the second zone, and each are configured with one or more vents, each of the vents having an adjustable opening allowing the transfer of air from the duct;
based upon the instructions, causing an adjustment to one or more of: a position of the openings of the vents, an operation of the first refrigeration unit, and an operation of the second refrigeration unit, the adjustment being effective to maintain the first temperature in the first zone and the second temperature in the second zone.

13. The method of claim 12, wherein the adjustment is determined by one or more of: a first measured temperature in the first zone and a second measured temperature in the second zone; a measured exterior temperature of the environment exterior to the vehicle; a first operational condition of the first refrigeration unit and a second operational condition of the second refrigeration unit; and a first type of product stored in the first zone and a second type of product stored in the second zone.

14. The method of claim 12, wherein the instructions define a number of vents to open and close in the first zone and the second zone.

15. The method of claim 12, wherein the number of vents to open and close in the first zone and the second zone is determined at the central processing center based at least in part upon sensed temperature readings obtained in the first zone and the second zone, the readings being transmitted to the central processing center by the transceiver circuit via the network.

16. The method of claim 12, wherein the position of the vents includes a fully open position and a fully closed position.

17. The method of claim 12, wherein the instructions cause the first refrigeration unit and the second refrigeration unit to be operating at the same time.

18. The method of claim 12, further comprising detecting a failure of the first refrigeration unit.

19. The method of claim 18, wherein upon detection of the failure, transmitting a message identifying the failure.

20. The method of claim 12, wherein the bulkhead includes a damper.

21. The method of claim 20, wherein a position of the damper is adjustable by the control circuit.

22. The method of claim 12, wherein the bulkhead is one of: a curtain-like bulkhead, or an inflatable bulkhead.
